(19) United States
(12) Patent Application Publication
(10) Pub. No.: US 2006/0178128 A1
(43) Pub. Date: Aug. 10, 2006

(54) Method of operating a mobile communication device and mobile communication system during an emergency situation

(76) Inventors: Eric T. Eaton, Lake Worth, FL (US); Scott M. Garrett, Weston, FL (US); Camilo E. Villamil, Pembroke Pines, FL (US)

Correspondence Address: Scott M. Garrett;Motorola, Inc., Law Department, 8000 West Sunrise Boulevard, Fort Lauderdale, FL, 33322, US

(21) Appl. No.: 10/742,691

(22) Filed: Dec. 19, 2003

(51) Int. Cl. H04M 11/04

(52) U.S. Cl. 455/404.1

(57) ABSTRACT

A mobile communication system (400) provides communication service in a plurality of serving cells. Upon the occurrence of an emergency situation, the mobile communication system determines which of the serving cells are affected by the emergency (402), and begins broadcasting an emergency notification message in the affected cells. Mobile communication devices in the affected cells will only be allowed to communicate a status message to inform others of the user's status, or if the user is an emergency subscriber, the emergency subscriber will receive regular communication service. All other communication service requests will be ignored during the emergency situation.

### TECHNICAL FIELD

This invention relates in general to mobile wireless communications, and more particularly to operating mobile communication devices in emergency situations to reduce system burden while maximizing the ability of subscribers to let other know their status.

### BACKGROUND OF THE INVENTION

Mobile communication devices are in widespread use and have become especially common in metropolitan areas. Originally these devices supported mobile radio telephony service, allowing users to both communicate without a land line telephone, and to move while engaged in a telephone call. More recently, however, these device have been developed to support a wide variety of communication and personal services. Most mobile communication devices presently sold include a network interface for sending and receiving data and data messages. The ability to engage in data communications has transformed mobile communication devices into personal communication assistants, allowing for a wide variety of applications to be used on the mobile communication device, including application for portable application environments, such as Java.

The advancement of mobile communications has enabled society to be more mobile, and many people depend on their mobile communication device to keep in touch, not just with business associates, but with friends and family as well. Communication system operators tend to build communication systems to maximize system use, but provide enough resources to handle periods of increased demand. However, emergency situations occasionally arise in heavily populated areas. During emergency situations, communication system resources in the affected areas quickly reach capacity, and leave many subscribers unable to acquire communication service to let other know of their status. Furthermore, people who are working to address the emergency situation are also unable to use the communication system because of the heavy traffic. Therefore there is a need for a method of operating communication devices and communication systems that allow subscribers to report their status, without allowing subscribers to tie up communication resources and allow others to acquire communication service.

### BRIEF DESCRIPTION OF THE DRAWINGS

FIG. 1 shows a system diagram of a mobile communication system, in accordance with the invention;

FIG. 2 shows a flow chart diagram of a method of operating a mobile communication device in an emergency situation, in accordance with the invention;

FIG. 3 shows a flow chart diagram of a method of operating a portion of a mobile communication system during an emergency situation, in accordance with the invention;

FIG. 4 shows a mobile communications serving area, including a region experiencing an emergency situation; and

FIG. 5 shows a signal flow chart of call handling in a mobile communication system during an emergency situation, in accordance with the invention.

### DETAILED DESCRIPTION OF A PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

The invention solves the problem of overloading mobile communication serving areas during emergencies by alerting users of the emergency and inhibiting regular mobile communication operation. Instead, users in affected areas are only allowed to transmit short status messages. By inhibiting regular operation and only permitting short message to be sent, more subscribers will be able to at least notify others that they are safe or otherwise not seriously affected by the event giving rise to the emergency. The invention also allows certain subscribers, such as emergency workers, to have regular operation in the affected locations while regular subscribers are inhibited in emergency mode.

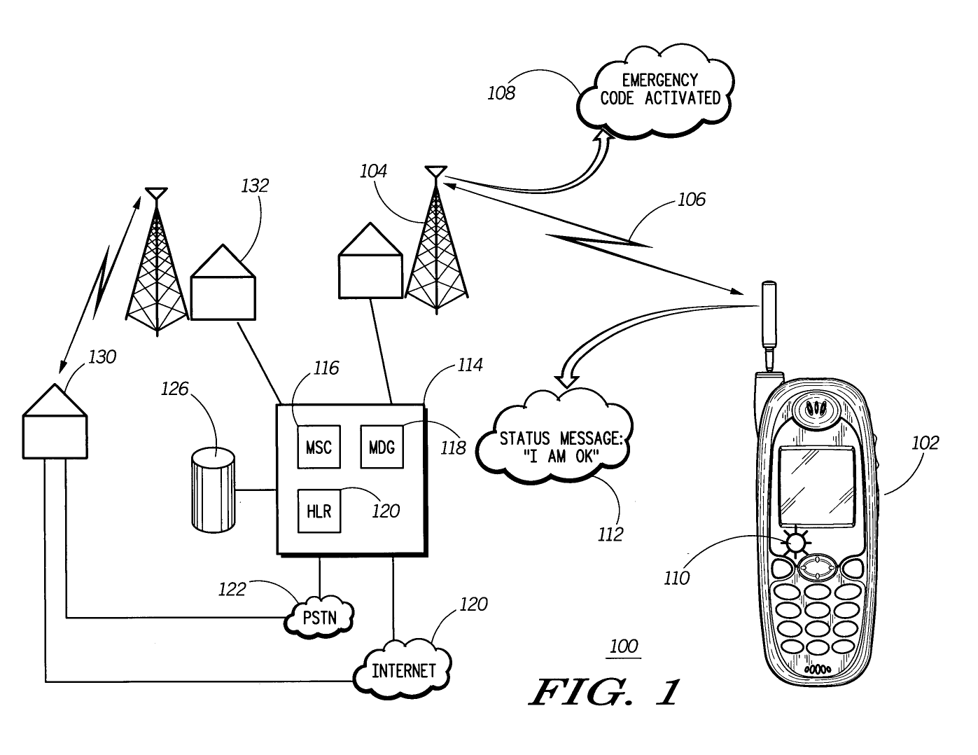

Referring now to FIG. 1, there is shown a system diagram of a mobile communication system 100 in accordance with the invention. The mobile communication system facilitates mobile communication by mobile communication devices such as mobile communication device 102. The mobile communication device communicates with a base station 104 via an air interface 106. The base station establishes a serving area or cell in the vicinity of the base station, and provides communication service to mobile communication devices in the serving area. Upon the occurrence of an emergency situation in the area of the base station, the base station broadcasts an emergency notification message. The emergency could be any one of a variety of emergency situations, but is one that affects a large number of people, or a large area, such as, for example, earthquakes, tornados, transportation accidents such as plane or train accidents, and so on. Once the mobile communication device receives the emergency notification message, it changes from a regular mode of operation to an emergency mode of operation and alerts the user. The mobile communication device may alert the user by a variety of means, including visually, audibly, and mechanically, or a combination of these. For example, the mobile communication device may make a sound and flash a light element behind a status response button 110. The mobile communication device may also display an icon or other graphic image on a display of the mobile communication device. While in the emergency mode of operation, the mobile communication device will not allow the user to engage in normal communications activity, such as a phone call. Instead, however, the mobile communication device will allow the user to send a status message 112. The status message is a short data communication message that informs a remote party as to the status of the user of the mobile communication device. It may be a canned, preselected message, or the mobile communication device may allow the user to enter a message. The remote party may be a preselected party, or the user may designate the party and provide calling/addressing information of the remote party so the communication system can route the message to the remote party. Alternatively, the message may simply be transmitted to the base station, which informs the communications system of reception of the message. In turn the communication system may update, for example, a voice mail greeting associate with the user's account so that when remote parties call the user, and are redirected to the user's voice mail, they hear the system greeting which announces, for example, the time of the last status message received from the user.

The communication system comprises a central office 114 which includes a mobile switching center 116 and a mobile data gateway 118. To verify a subscriber's identity, the central office also comprises a home location register 120, which includes a record corresponding to the subscriber and information for authenticating the subscriber's mobile communication device, as is well known in the art. The central office provides connectivity to the public switched telephone network 122 and the Internet 124, allowing subscribers to access these extra-system networks and communicate with people outside of the communication system. The communication system also comprises a voice mail server 126 so that subscribers may receive voice mail when out of the service area, or when their mobile communication device is not on. A subscriber's voice mail service typically allows a subscriber to record a greeting that callers hear when they reach the subscriber's voice mailbox, or a default greeting if the subscriber does not wish to provide a personalized greeting. In one embodiment of the invention, in the event of an emergency, the subscriber's voice mail greeting is changed if the subscriber is located in an area affected by the emergency situation when the subscriber sends a status message. The emergency voice mail greeting announces the time of the subscriber's last status message so that when callers call the subscriber, and a redirected to the subscriber's voice mail, they hear the announcement and time of the last status update to provide a measure of peace of mind. In an alternative embodiment the status message is sent from the mobile communication device to a remote party 130. The message may be transmitted by a variety of means, including the PSTN 122, over which a short, prerecorded voice message may be sent, or by the Internet 124 such as by an email message. The status message can also be sent to another mobile communications subscriber by a nearby base station 132 after the message propagates through the mobile communication system. It is contemplated that the status message may be created at the mobile communication device while the mobile communication device is operating in the emergency mode, or, alternatively, the status message may simply be a control message transmitted to the mobile communication system which in turn takes a predetermined action in response to receiving the status message.

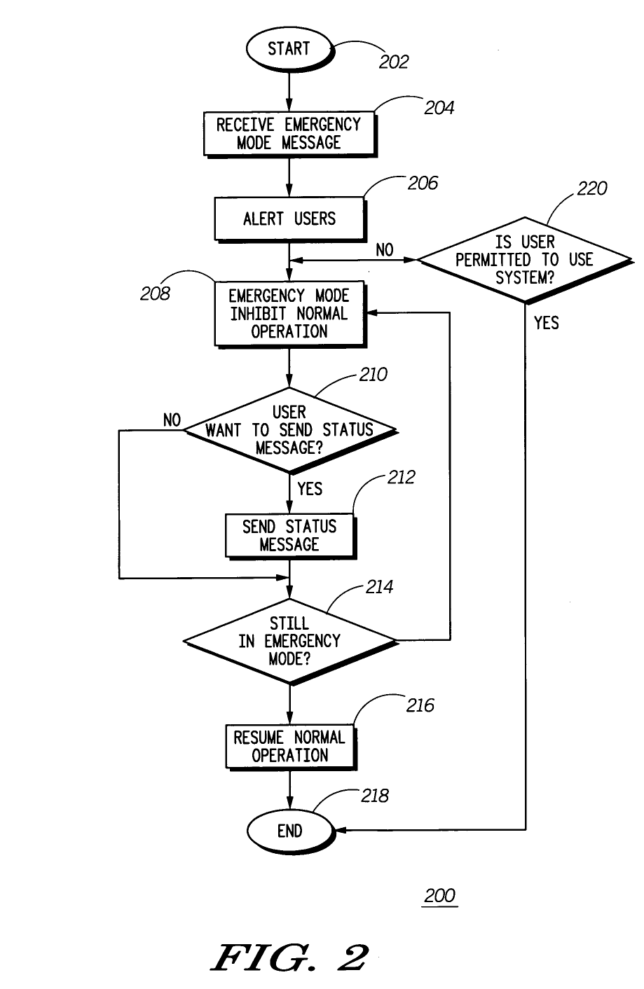

Referring now to FIG. 2, there is shown a flow chart diagram 200 of a method of operating a mobile communication device in an emergency situation in accordance with the invention. At the start 202 the mobile communication device is powered up and registered with the mobile communication system so as to engage in communication. The mobile communication device is camped on a particular cell of the mobile communication system, meaning the mobile communication device will communicate with the base station transceiver establishing the cell or serving area to commence communication. The base station broadcasts a control channel that mobile communication devices in the cell monitor to receive information such as pages alerting the mobile communication device to incoming calls. For the present example the cell in which the mobile communication device is presently camped is affected by an emergency situation. Accordingly, the base station commences transmitting an emergency notification message, which is received by the mobile communication device (204). In response, the mobile communication device alerts the user (206). The alert can take any one or a combination of different forms, including visual, audible, tactile, and it is contemplated that scent may be used. In the preferred embodiment the mobile communication device flashes light emitting components, displays an emergency icon on a display of the mobile communication device, plays alert sounds, and activates a mechanical vibrator until the user recognizes the alert by, for example, pressing a button on the mobile communication device. In the preferred embodiment a status response button is disposed on the mobile communication device, and a light element is disposed inside the mobile communication device behind the status response button so as to backlight the status response button. The status response button can then be selectably illuminable so as to create a flashing effect to attract attention. Similarly, the entire keypad may be backlit, as is common, but it is contemplated that a different color backlighting be used for emergency mode than when operating in normal, non-emergency mode. It is also contemplated that the emergency notification message broadcast by the mobile communication system contains a short message to be displayed on the display of the mobile communication device, such as “evacuate the area,” for example. It is further contemplated that the mobile communication device may change from providing a standard user interface to providing an emergency user interface while in the emergency mode of operation. The emergency user interface informs the user of the emergency and may lock out the use of all buttons except for the status response button, for example.

In response to receiving the emergency notification message, the mobile communication device changes from a normal mode of operation to an emergency mode of operation (208). While in the emergency mode of operation, normal operation, such as making a phone call, are inhibited so as to prevent overloading the mobile communication system with call traffic from subscribers in the affected areas. However, the mobile communication device will permit the user to send a short status message when the user desires to do so (210). By limiting the length or duration of the message, the user is able to get out a message to others, and the communication resources of the affected cells are then able to service more people since the time needed to transmit the status message is far shorter than a typical phone call. The status message is created prior to sending and may be either a default message or one created by the user shortly before sending. The message may be sent by a regular phone channel by transmitting a prerecorded voice message of a preselected duration, or other modes of communication may be used to transmit text messages, such as short message service, or a message sent over a packet data link, for example. In an alternative embodiment, the user has predefined an emergency response profile, and designated a party or parties to be contacted, wherein the emergency response profile is saved on a server at the mobile communication system. In this alternative embodiment, rather than assigning the mobile communication device a channel to transmit the status response message after the mobile communication device transmits a request, the request itself triggers the mobile communication system to send a prerecorded message to the parties defined in the subscriber's emergency response profile. Once the user has selected the message, the user presses, for example, a status response button on the mobile communication device which causes the mobile communication device to transmit the status message (212). As long as the mobile communication device is receiving the emergency notification message from the present serving cell (214) the mobile communication device will continue to inhibit the normal mode of operation, and allow only the emergency mode of operation where only a status message can be sent. It is further contemplated that the mobile communication device restricts the number of status messages that can be sent in a given period of time, such as by, for example, allowing one status message to be sent ever ten minutes. No time period is preferred and it is left as a matter of engineering choice to decide if such a restriction is needed, and if so, how long the time period between status messages must be. If the present serving cell stops broadcasting the emergency notification message, or of the mobile communication device moves to a new cell that is not broadcasting the emergency notification message, the mobile communication device may then resume normal operation (216) and the method ends (218).

In the preferred embodiment, certain mobile communication devices will not inhibit normal operation and switch to emergency operation mode. For example, volunteer emergency workers will need to be able to communicate with others. These mobile communication devices are referred to as emergency response mobile communication devices, and they are provided with different instruction code than regular mobile communication devices designed in accordance with the invention, as described thus far. After the emergency response mobile communication devices receive the emergency notification message and alert the user, the mobile communication device determines if it is an emergency response mobile communication device, or if the user is otherwise permitted to continue using a normal mode of operation of the mobile communication device (220). For example, a special key may be disposed in a reserved section of memory in a serial inline module (SIM) used in the mobile communication device. The presence of the key authorizes the mobile communication device to continue operating in the normal mode as the presence of the key indicates the user is an authorized emergency worker.

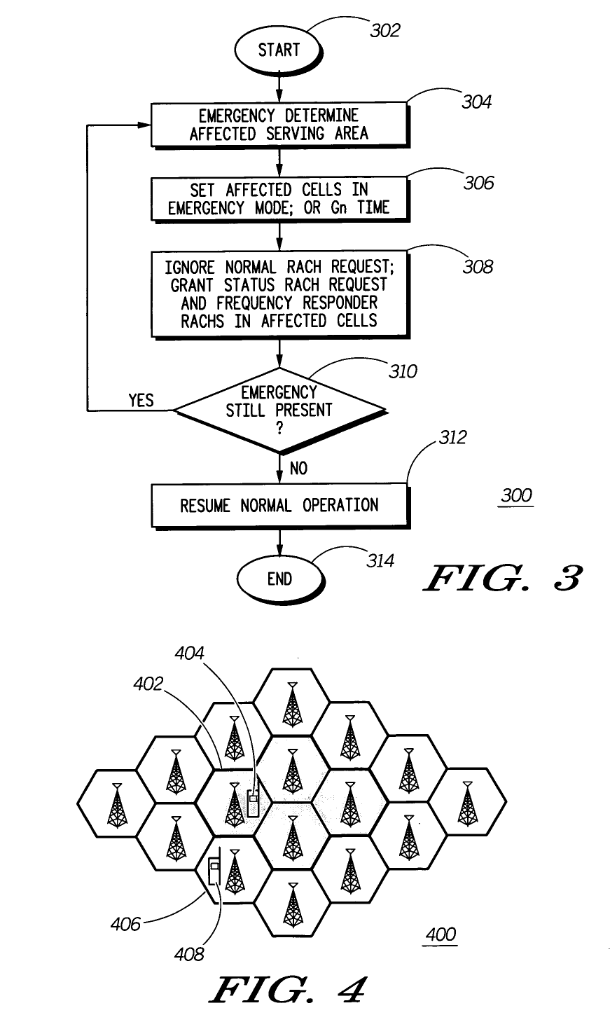

Referring now to FIG. 3, there is shown a flow chart diagram 300 of a method of operating a portion of a mobile communication system during an emergency situation in accordance with the invention. Initially the mobile communication system is operating normally, and some event occurs giving rise to an emergency situation in a portion of the mobile communication system. In response the mobile communication system operator determines the affected area (304) and commands the affected cells to commence emergency mode, wherein the affected cells begin broadcasting an emergency notification message on a broadcast control channel (306). FIG. 4 illustrates mobile communication system in which an emergency has occurred. FIG. 4 shows a mobile communications serving area 400, made up of a plurality of serving cells, and including a region 402 experiencing an emergency situation, which is represented by the grayed region outlined in bold. A mobile communication device in the affected area 404 will operate in emergency mode, while a mobile communication device 408 in an unaffected cell 406 will operate normally.

Cells operating in emergency mode may receive requests for normal service, which is commonly performed on a random access channel (RACH). It is contemplated that there may be mobile communication devices in the affected area that are not designed in accordance with the teachings described herein in regard to FIG. 2, such as older, legacy mobile communication devices. These mobile communication devices will not prevent their users from requesting communication service. However, the mobile communication system can distinguish these legacy mobile communication devices and ignore their service requests. However, in order for mobile communication device to transmit status message, it must receive a channel assignment, and so transmits a status RACH request, which specifically identifies to the mobile communication system that the requesting mobile communication device intends only to transmit a status message. Accordingly the mobile communication system will grant a channel assignment to the requesting mobile communication device to do so, in accordance with the invention. Alternatively, the requesting mobile communication device may be an emergency responder, and upon being authenticated as such, such as may be indicated in the requesting subscriber's HLR record, the mobile communication system will grant communication service of the subscriber can commence communicating. Thus, as indicated by block 308, the mobile communication system ignores legacy mobile communication device service requests, and grants status service request and emergency responder service requests. The mobile communication system continues to grant service requests in accordance with block 308 so long as the affected cells are operating in emergency mode, as indicated by decision block 310. Periodically the mobile communication system may reevaluate the affected cells and change some to emergency mode while changing some back to normal mode. Cells which are no longer affected by the emergency situation resume normal operation (312), whereupon the method ends (314) for those cells.

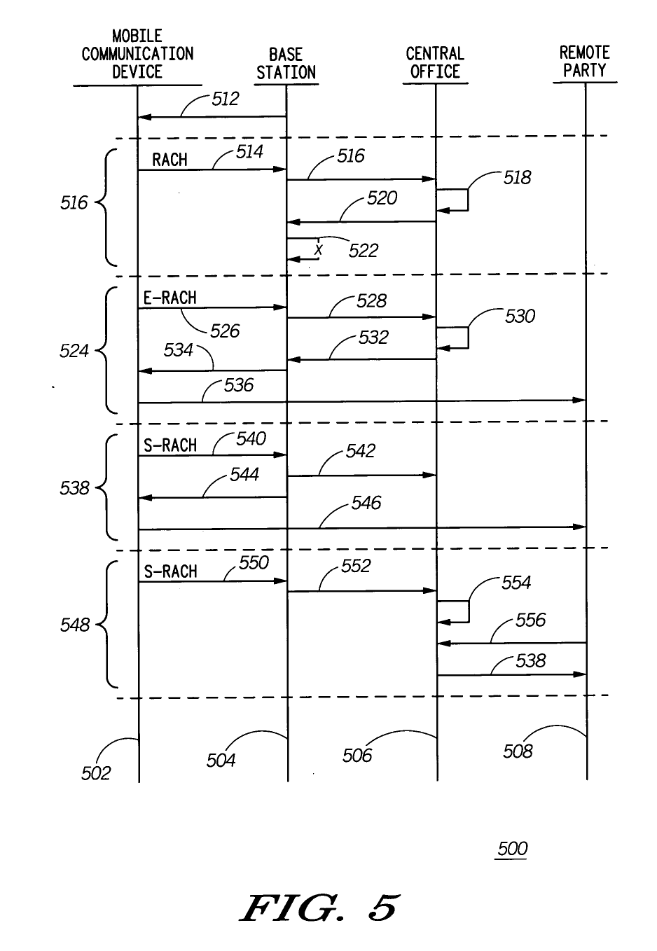

Referring now to FIG. 5, there is shown a signal flow chart 500 of call handling in a mobile communication system during an emergency situation in accordance with the invention. There are four entities discussed here, each represented by a vertical line. Horizontal lines indicate signals sent from one entity to another. The entities involved in the mobile communication system are a mobile communication device 502; a base station 504 presently providing communication service to the mobile communication device and other mobile communication devices in the base station's serving area; the mobile communication system's central office 506; and a remote party 508 to which the user of the mobile communication device wishes to transmit a status message. Shown here are four different scenarios, as indicated by 510, 524, 538, and 548. Each scenario begins when the base station 504 providing the serving area in which the mobile communication device 502 is presently located transmits an emergency notification message 512, that is received by the mobile communication device.

In the first scenario 510, the mobile communication device is a mobile communication device designed in accordance with the prior art, and hence does not respond to the emergency notification message in accordance with the invention as it pertains to mobile communication devices. Subsequent to the base station changing to an emergency mode of operation the prior art mobile communication device attempts to make initiate a call by first transmitting a channel request over a random access channel (RACH) (514). Since, in one embodiment of the invention, some mobile communication devices may be granted regular communication service, the base station forwards the request to the central office (516). The central office checks the home location register and subscriber records for the requesting mobile communication device (518) and determines that it is not one of the authorized mobile communication devices that are allowed to receive communication service during emergency situations, and informs the base station of such (520). The base station then ignores the request and all future requests from the prior art mobile communication device (522) until the base station resumes normal operation. Alternatively, the base station may transmit a “system busy” message.

In a second scenario 524, the requesting mobile communication device is a mobile communication device assigned to an emergency response subscriber, such as, for example, a volunteer firefighter. The user of this type of mobile communication device is referred to an emergency subscriber (ES). The emergency subscriber's mobile communication device transmits a RACH request to initiate a call or other communication (540), and including calling information for a remote party, such as a phone number. It is contemplated that the request may indicate the requester is an ES. The base station receives the request and forwards the request to the central office (528). The central office authenticates the ES status of the requester (530), and commences setting up a call circuit, and notifies the base station to allow the call (532). The base station then transmits a channel assignment to the mobile communication device (534), and the mobile communication device commences communicating with the remote party (536).

A third scenario 538 begins when a non-emergency subscriber using a mobile communication device designed in accordance with the invention as it pertains to mobile communication devices initiates a service request to transmit a status message (540), including the calling information of a third party. The mobile communication device, having received the emergency notification message, is operating in emergency mode when the user decides to send a status message to a remote party. The request is forwarded to the central office (542) to commence setting up a call circuit or data circuit, depending on the type of call being made to transmit the status message. The base station transmits a channel assignment to the mobile communication device (544), and the mobile communication device transmits the status message to the remote party (546). The status message is prerecorded, and sent by any one of a variety of calling or messaging means known in the art, such as, for example, short message service, packet data, voice telephony, and so on.

In a fourth scenario 548, the mobile communication device is also a non-emergency subscriber using a mobile communication device designed in accordance with the invention as it pertains to mobile communication device. The mobile communication device initiates a status service request (550). However, unlike the third scenario where the mobile communication device communicates directly with the remote party, in this embodiment the mobile communication device requests the mobile communication system update a status message that remote parties can hear upon calling the mobile communication device subscriber. Hence, the request is forwarded to the central office (552), and the central office updates a status message (554), such as a voice mail greeting for the subscriber's voice mail. When a remote party calls the subscriber (556), the remote party will hear the updated status message (558).

Alternatively, similarly to the scenario 548, the mobile communication device uses the random access channel to transmit a status service request (550) to the mobile communication system much the way it does when requesting communication service. However, rather than requesting communication service, the mobile communication device indicates the request is for the mobile communication system to send a status message to a party previously selected and described in the subscriber's emergency profile, which is stored on a server of the mobile communication system. When the base station receives the request, it forwards it to the central office (552). Equipment at the central office retrieves the subscriber's emergency profile, and obtains the calling or messaging information for other parties stored therein, and commences sending status messages to those parties.

Thus, the invention provides a method of operating a mobile communication device during an emergency situation, beginning by receiving an emergency notification message at the mobile communication device from the communication system providing communication service to the mobile communication device. In response, the mobile communication device commences transitioning from a regular mode of operation to an emergency mode of operation, and allows only a status message to be transmitted from the mobile communication device while in the emergency mode of operation. If the mobile communication system ceases transmitting the emergency notification message, or if the mobile communication device moves into a serving area that is not affected by the emergency situation, the mobile communication device resumes normal operation. In the preferred embodiment, once the emergency notification message is received, the mobile communication device alerts the user of the mobile communication device, such as by providing a visual alert, illuminating a status response button of the mobile communication device, displaying an icon on a display of the mobile communication device, providing an audible alert, providing a tactile alert, actuating a mechanical vibrator of the mobile communication device, or any combination thereof. Preferably, the mobile communication device receives the emergency message in a broadcast control channel transmitted by the communication system at a base station presently providing communication service in the serving are in which the mobile communication device is presently located. The status message may be transmitted in response to actuation of a status response button disposed on the mobile communication device, and used in conjunction with an emergency user interface. The status message may be transmitted by short message service message, as well as packet data and by sending a prerecorded voice message by regular telephony channels. The status message may be communicated to a remote party, or the status message may be a communicated to the mobile communication system, which causes an update of a status update server of the communication system, such as a voice mail greeting for the user.

The invention also provides a method of operating a mobile communication system during an emergency situation, by determining which of a plurality of serving cells of the mobile communication system are affected cells, the affected cells being serving cells affected by the emergency situation. Once the affected cells has been determined, the communication system operator commands each affected cell to begin broadcasting an emergency notification message. While in an emergency mode, the affected calls will provide communication service to mobile communication devices which are either transmitting a status message or are known emergency responders, and will deny communication service to all other mobile communication devices.

It is further contemplated that the invention provides a method of operating a mobile communication system during an emergency situation by receiving a channel request from a mobile communication device at a base station, the base station having been determined to be in an area affected by the emergency situation. If the channel request indicates the mobile communication device intends to transmit a status message, the mobile communication system commences granting the request, receiving the status message from the mobile communication device, and forwarding the status message to a remote party. If the channel request indicates the mobile communication device is an emergency subscriber, the mobile communication system commences granting the request and allowing the emergency subscriber to have normal communication service. If the channel request is not from either an emergency subscriber or a mobile communication device desiring to transmit a status message the mobile communication system ignores the channel request.

It is still further contemplated that the invention provides a method of operating a mobile communication device of an emergency subscriber during an emergency situation, wherein the method commences by transmitting a communication service request to a base station, wherein the base station is operating in an emergency mode, and the communication service request contains a subscriber identifier for identifying the emergency subscriber. The mobile communication system processes and grants the request. The mobile communication device receives a channel assignment indicating an assigned channel to be used by the emergency subscriber, and the mobile communication device commences communication on the assigned channel.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method of operating a mobile communication device during an emergency situation, comprising:
receiving at the mobile communication device from a communication system an emergency message;
transitioning the mobile communication device from a regular mode of operation to an emergency mode of operation in response to receiving the emergency message; and
allowing only a status message to be transmitted from the mobile communication device while in the emergency mode of operation.

2. A method of operating a mobile communication device as defined in claim 1, further comprising alerting a user of the mobile communication device in response to receiving the emergency message.

3. A method of operating a mobile communication device as defined in claim 2, wherein alerting the user comprises providing a visual alert.

4. A method of operating a mobile communication device as defined in claim 3, wherein providing a visual alert comprises illuminating a status response button of the mobile communication device.

5. A method of operating a mobile communication device as defined in claim 3, wherein providing a visual alert comprises displaying an icon on a display of the mobile communication device.

6. A method of operating a mobile communication device as defined in claim 2, wherein alerting the user comprises providing an audible alert.

7. A method of operating a mobile communication device as defined in claim 2, wherein alerting the user comprises providing an tactile alert.

8. A method of operating a mobile communication device as defined in claim 2, wherein providing the tactile alert comprises actuating a mechanical vibrator of the mobile communication device.

9. A method of operating a mobile communication device as defined in claim 1, wherein receiving the emergency message comprises receiving the emergency message in a broadcast control channel transmitted by the communication system.

10. A method of operating a mobile communication device as defined in claim 1, wherein allowing only the status message to be transmitted comprises transmitting the status message in response to actuation of a status response button.

11. A method of operating a mobile communication device as defined in claim 1, wherein allowing only the status message to be transmitted comprises transmitting the status message in a short message service message.

12. A method of operating a mobile communication device as defined in claim 1, wherein allowing only the status message to be transmitted comprises transmitting the status message to a remote party via the communication system.

13. A method of operating a mobile communication device as defined in claim 1, wherein allowing only the status message to be transmitted comprises transmitting the status message to a status update server of the communication system.

14. A method of operating a mobile communication system during an emergency situation, comprising:
determining which of a plurality of serving cells of the mobile communication system are affected cells, the affected cells being serving cells affected by the emergency situation,
broadcasting in each of the affected cells an emergency notification message; and
providing communication service to mobile communication devices which are either transmitting a status message or are known emergency responders, and denying communication service to all other mobile communication devices.

15. A method of operating a mobile communication system during an emergency situation, comprising:
receiving a channel request from a mobile communication device at a base station, the base station having been determined to be in an area affected by the emergency situation;
if the channel request indicates the mobile communication device intends to transmit a status message, granting the request, receiving the status message from the mobile communication device and forwarding the status message to a remote party.
if the channel request indicates the mobile communication device is an emergency subscriber, granting the request and allowing the emergency subscriber to have normal communication service; and
ignoring the channel request if the channel request is not from an emergency subscriber or for transmitting a status message.

16. A method of operating a mobile communication device of an emergency subscriber during an emergency situation, comprising:
transmitting a communication service request to a base station, the base station operating in an emergency mode, the communication service request containing a subscriber identifier for identifying emergency subscriber;
receiving at the mobile communication device a channel assignment indicating an assigned channel to be used by the emergency subscriber; and
commencing communication on the assigned channel.

17. A method of operating a mobile communication system during an emergency situation, the mobile communication system having an emergency profile server, the method comprising:
receiving a status service request over a random access channel at a base station of the mobile communication system from a subscriber;
retrieving an emergency profile corresponding to the subscriber, the emergency profile indicating at least one party to be contacted in the event of an emergency situation; and
transmitting a status message to the at least one party indicated in the emergency profile.
